(19) United States
(12) Patent Application Publication
(10) Pub. No.: US 2012/0055060 A1
(43) Pub. Date: Mar. 8, 2012

(54) ERGONOMIC GRIP INSERT FOR FIREARM

(76) Inventors: Steve Hines, Edgewood, NM (US); Michael B. Bietsch, Rio Rico, AZ (US)

(21) Appl. No.: 12/877,790

(22) Filed: Sep. 8, 2010

(51) Int. Cl. F41C 23/16; B23P 11/00

(52) U.S. Cl. 42/71.01; 29/428

(57) ABSTRACT

A firearm handgrip can be modified to accept an ergonomic insert that changes the palm relief of a firearm. The palm relief is the handgrip profile that a shooter feels against the palm of the hand when holding the firearm. The ergonomic insert can be releasable from the handgrip, perhaps by unpinning, such that other inserts can be inserted. As such, a person can try a variety of ergonomic inserts until the best insert for that particular person is determined. For certain semiautomatic pistols, cutting away a back portion of the handgrip produces the socket portion of a dovetail joint. An insert having a properly sized dovetail can slide into the socket and be held there. In this manner, a family of ergonomic inserts and a machining service can be offered to thereby provide firearms having interchangeable ergonomic inserts and thereby a customized and ergonomic grip.

### TECHNICAL FIELD

Embodiments relate to the fields of small arms, pistol hand grips, polymer handgun frames, ergonomics, and firearm accessories.

### BACKGROUND

Firearms are massed produced in a one size fits all type scheme. Fitting a firearm to a shooter is typically a very expensive proposition requiring custom and expert gunsmithing. Most shooters avoid the cost of custom work but do try different firearm models until finding a gun that fits. Some shotguns are provided with shims and a selection of butt plates to thereby provide a certain level of easy customization. Furthermore, many carbines are offered with sliding and configurable stocks.

Firearms having mounting rails such as the pervasive Picatinny rail systems can be fitted with interchangeable forward handgrips although most of the forward handgrips are roughly cylindrical. The ability to move the handgrip to a preferred spot on a mounting rail does provide a certain level of ergonomic customization.

Interchangeable handgun grips that are typically bolted on side panels or their wrap around and bolt on cousins have been offered. These customizations do provide a level of ergonomic customization that many shooters have welcomed. The bolt-on grips have lost some popularity with the advent of polymer handgun frames because the polymer frames have molded in side panels and do not graciously accept tapping and threading like their aluminum and steel predecessors cousins do.

Firearm frames are produced as a single piece. Originally, they were cast as a single piece or milled from a single piece of metal. More recently, firearm frames are molded from plastic. Metallic pieces can be placed into the mold before plastic is injected or otherwise introduced. This technique produces frames that are a single piece that is plastic reinforced or otherwise improved by the inclusion of metal. For example, a substantially plastic firearm frame can have metallic runners for the slide and glass reinforced resin as the plastic.

U.S. Pat. No. 7,506,469, herein incorporated by reference, to Poulin teaches a firearm frame with a configurable grip. The frame is produced with standoffs on the back side of the magazine well. A large pin holds a removable grip portion to the back of the magazine well.

U.S. Pat. Nos. 4,539,889, 4,825,744 and 4,893,546, herein incorporated by reference, to Glock teach key features of a Glock style firearm. FIG. 11, labeled as “Prior Art” illustrates a Glock style firearm 1100. The firearm frame 1101 is a single piece having a trigger guard 1102, magazine well 102, back cavity 1106, handgrip 1111, and pinning holes 1107, 1109. The back cavity 1106 is an open cavity formed by the back of the magazine well 102 and the rear wall 1110 of the frame 1101. A magazine 1105 is shown in the magazine well 102. A slide 1108 rides on top of the frame 1101.

FIG. 12, labeled as “Prior Art”, illustrates a trigger assembly 1204. The trigger assembly for this particular style of firearm has a trigger 1103 connected to a block 1202 by a trigger slide 1203. A pinning hole 1202 provides a means for fixing the block 1201 inside a firearm frame 1101.

FIG. 13, labeled as “Prior Art”, illustrates a trigger assembly 1204 inside a firearm frame 1101. A pin 502 through pinning holes 1107 and 1202 holds the block 1201 in position within the firearm frame 1101.

The illustrated prior art firearms have frames that are molded as a single piece and that single piece includes the palm relief. The palm relief is on the back of the firearm handgrip and is the area where a shooters palm contacts the firearm. As such all shooters, regardless of hand size, use the same sized grip. Systems and methods for ergonomically customizing handgrips, and in particular the handgrips of polymer framed handguns, are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

Methods for modifying a firearm to use interchangeable ergonomic inserts to customize the handgrip are provided. Current generation handguns can be easily modified to accept the inserts such that a shooter can choose from a selection of inserts and thereby obtain a custom grip and feel.

Many firearms have a back cavity behind the magazine well. Both the magazine well and the back cavity are open cavities with openings on the bottom. A magazine can be inserted into the magazine well. The back cavity typically remains open although some people block them to thereby prevent dirt from entering the back cavity. A common wall, separating the back cavity from the magazine well, is also the back of the magazine well. Machining the rear wall further opens the back cavity and also produces a retention socket.

An ergonomic insert for a handgrip can have a palm relief, a retention structure such as a dovetail, and a pinned extension. The retention structure can be sized to match the retention socket produced by machining the rear wall. A dovetail socket is an example of a retention socket that matches a dovetail.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a modified handgrip with an insert producing an ergonomic profile in accordance with aspects of the embodiments;

FIG. 2 illustrates a modified handgrip with an insert producing a different ergonomic profile in accordance with aspects of the embodiments;

FIG. 3 illustrates a view from the bottom and up into the magazine well of a modified handgrip in accordance with aspects of the embodiments;

FIG. 4 illustrates a side view of a modified handgrip with an insert producing an ergonomic profile in accordance with aspects of the embodiments;

FIG. 5 illustrates a cut view of the modified handgrip and insert of FIG. 4 in accordance with aspects of the embodiments;

FIG. 6 illustrates a cut view of the modified handgrip of FIG. 5 with the insert removed in accordance with aspects of the embodiments;

FIG. 7 illustrates a side profile of an ergonomic insert in accordance with aspects of the embodiments;

FIG. 8 illustrates a side view of an ergonomic insert in accordance with aspects of the embodiments;

FIG. 9 illustrates another view of the ergonomic insert of FIG. 8 in accordance with aspects of the embodiments;

FIG. 10 illustrates a bottom view of the ergonomic insert illustrated in FIGS. 7-9 in accordance with aspects of the embodiments;

FIG. 11, labeled as “Prior Art”, illustrates a firearm;

FIG. 12, labeled as “Prior Art”, illustrates a trigger assembly;

FIG. 13, labeled as “Prior Art”, illustrates a trigger assembly inside a firearm frame;

FIG. 14 illustrates a side view of a modified handgrip with an insert producing an ergonomic profile in accordance with aspects of alternate embodiments;

FIG. 15 illustrates a view from the bottom and up into the magazine well of a modified handgrip in accordance with aspects of alternate embodiments;

FIG. 16 illustrates another alternative for fixing an insert into a handgrip in accordance with aspects of alternate embodiments; and

FIG. 17 illustrates yet another alternative for fixing an insert into a handgrip in accordance with aspects of alternate embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

A firearm handgrip can be modified to accept an ergonomic insert that changes the palm relief of a firearm. The palm relief is the handgrip profile that a shooter feels against the palm of the hand when holding the firearm. The ergonomic insert can be releasable from the handgrip, perhaps by unpinning, such that other inserts can be inserted. As such, a person can try a variety of ergonomic inserts until the best insert for that particular person is determined. For certain semiautomatic pistols, cutting away a back portion of the handgrip produces the socket portion of a dovetail joint. An insert having a properly sized dovetail can slide into the socket and be held there. In this manner, a family of ergonomic inserts and a machining service can be offered to thereby provide firearms having interchangeable ergonomic inserts and thereby a customized and ergonomic grip.

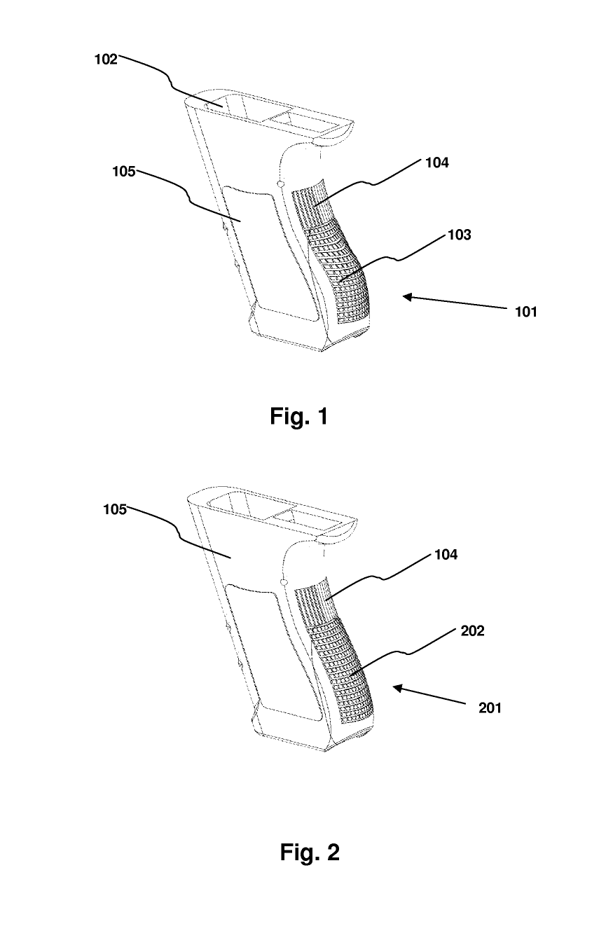

FIG. 1 illustrates a modified handgrip 105 with an ergonomic insert 103 producing an ergonomic profile 101 in accordance with aspects of the embodiments. The illustrated modified handgrip was initially the handgrip of a Clock style handgun frame. Those familiar with this polymer frame will realize that the forward part of the frame having the trigger housing and other elements is not shown. The magazine well 102 can be seen as is an area of the original texture 104.

FIG. 2 illustrates a modified handgrip 105 with an insert 202 producing a different ergonomic profile 201 in accordance with aspects of the embodiments. Here, the modified handgrip 105 is the same as that illustrated in FIG. 1. The ergonomic insert 202 is different. The second profile 201 can be seen to be flatter than the first profile 101. The different inserts produce different ergonomic profiles.

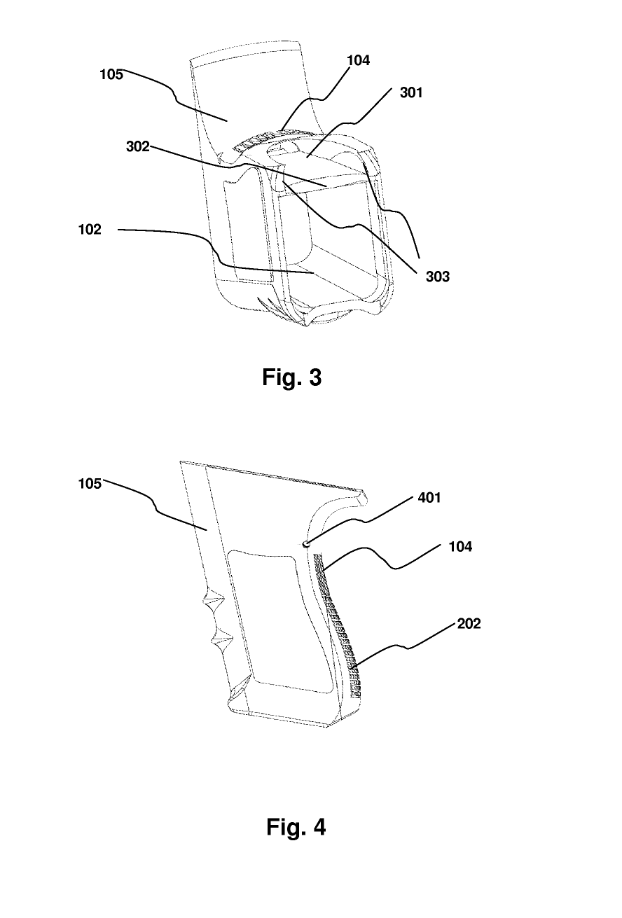

FIG. 3 illustrates a view from the bottom and up into the magazine well 102 of a modified handgrip 105 in accordance with aspects of the embodiments. As can be seen from the illustration, part of the back of a stock handgrip has been milled away to expose the magazine well backside 302. The remaining portion of the polymer frame and the magazine well backside 302 can be seen to have become retention sockets 303 and in fact the combination of elements is a dovetail socket 301. A simple cut through the polymer frame of a firearm has produced dovetail socket 301.

FIG. 4 illustrates a side view of a modified handgrip 105 with an insert 202 producing an ergonomic profile in accordance with aspects of the embodiments. A pinning hole 401 is also present in the stock polymer frame.

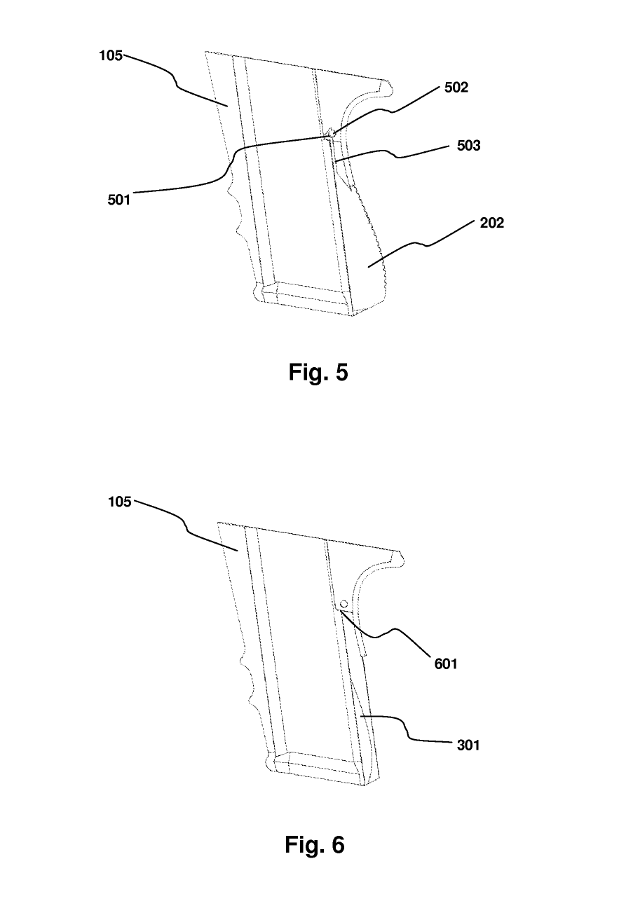

FIG. 5 illustrates a cut view of the modified handgrip 105 and insert 202 of FIG. 4 in accordance with aspects of the embodiments. A pin 502 in the pinning hole 401 is engaging the hooked end 501 of a pinned extension 503 that extends out of the ergonomic insert 202.

FIG. 6 illustrates a cut view of the modified handgrip 105 of FIG. 5 with the insert removed in accordance with aspects of the embodiments. The dovetail socket 301 can be seen as can a ledge 601. The ledge 601 is an original element of the stock polymer frame and can be advantageously used to help retain the pinned extension.

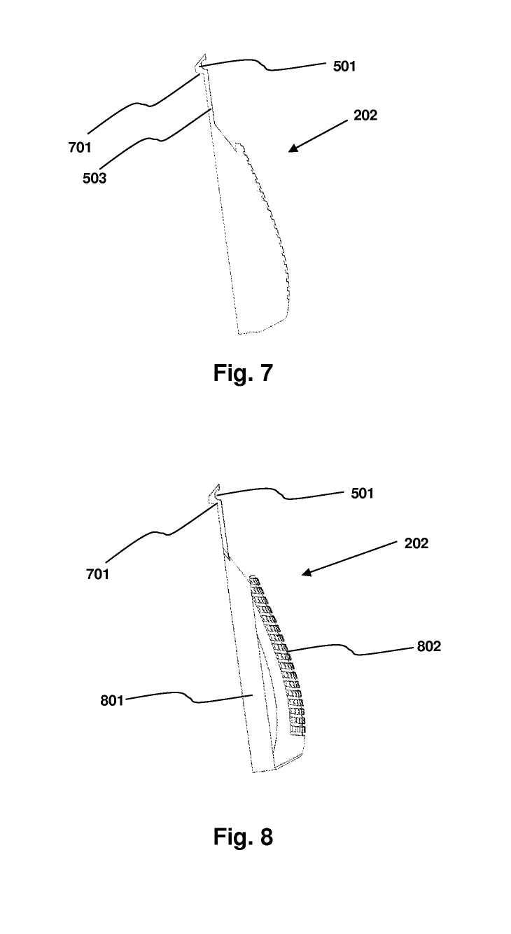

FIG. 7 illustrates a side profile of an ergonomic insert 202 in accordance with aspects of the embodiments. The ledge 601 of FIG. 6 matches a ledge engagement 701 in the pinned extension 503. The pin 502 in pinning hole 401 fits through the hooked end 501 and thereby prevents the ledge engagement 701 from slipping around and past the ledge 601.

FIG. 8 illustrates a side view of an ergonomic insert 202 in accordance with aspects of the embodiments. The palm relief area has a texture 802 that can be customized as well as the ergonomic profile provided by the insert. Different people prefer different textures as well as different profiles. A retention structure 801 is also visible. In this illustration the retention structure is one side of a dovetail.

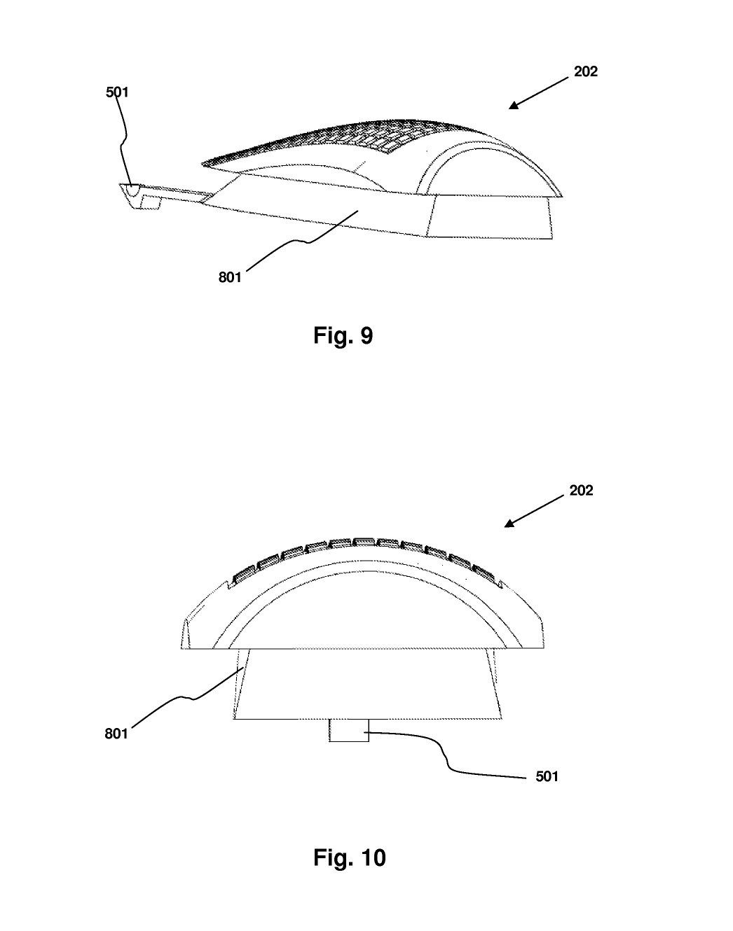

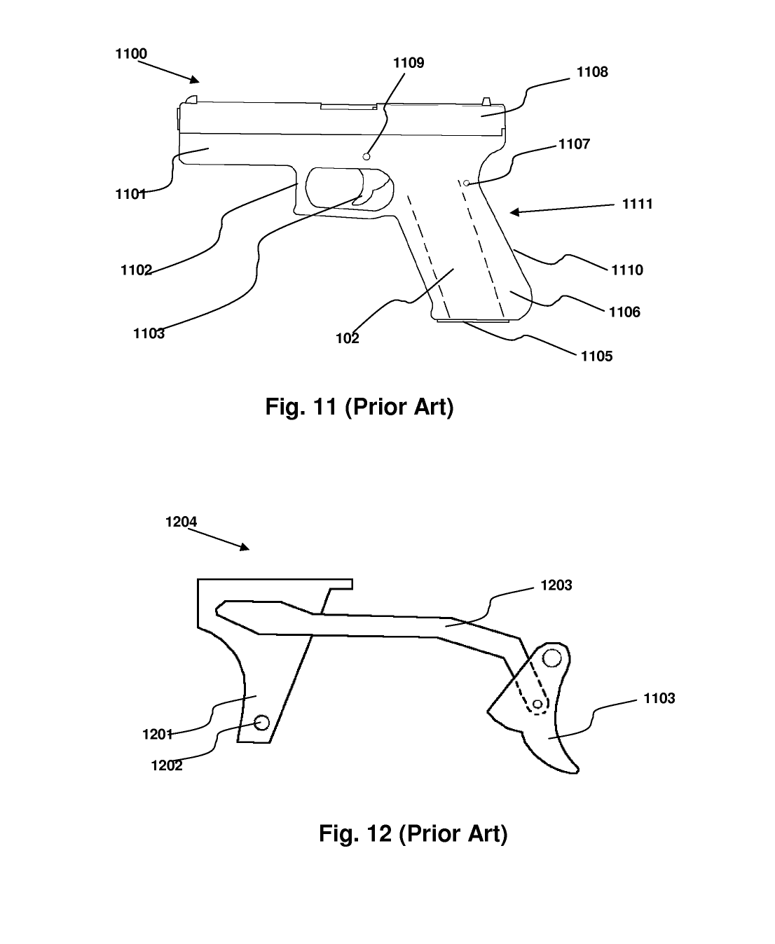

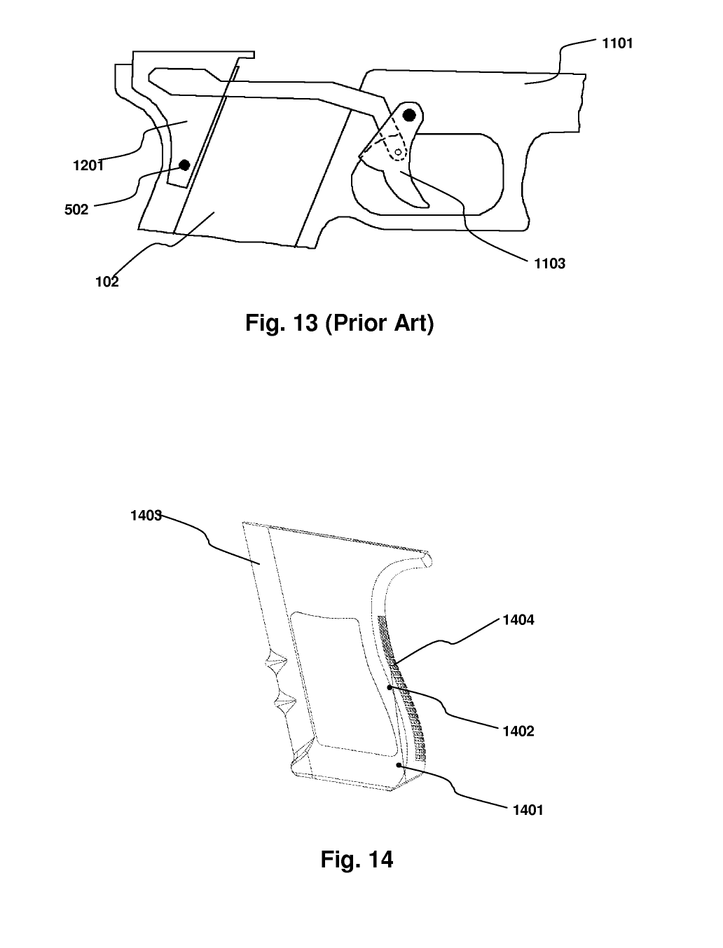

FIG. 9 illustrates another view of the ergonomic insert 202 of FIG. 8 in accordance with aspects of the embodiments. This view clearly shows that the insert's dovetail 801 is designed to slide into the dovetail socket 301 of the modified polymer frame 105. Specifically, the insert 202 slides in from the bottom until the hook 501 aligns with the pinning hole. Note that means other than the pinning extension can be used to retain the insert. However, the illustrated example is based on a stock polymer frame with advantageously placed ledge and pinning hole. For example, a detent formed into the magazine well backside can interlock with a bearing or nub in the insert. A pin hole could be drilled if one were not already available. Furthermore, the dovetail and dovetail socket can be curved such that the dovetail is retained by a snap over center effect.

FIG. 14 illustrates a side view of a modified handgrip 1403 with an insert 1404 producing an ergonomic profile in accordance with aspects of alternate embodiments. Two pinning holes have been formed into the polymer frame so that two pins 1401, 1402 can be inserted through the holes and through the insert 1404 to thereby fasten the insert and handgrip together.

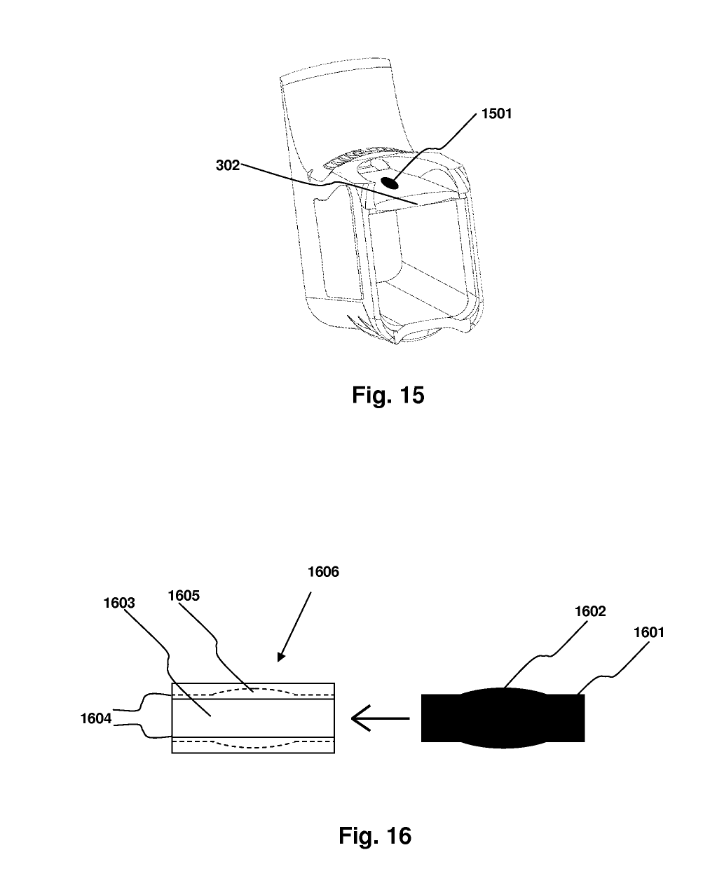

FIG. 15 illustrates a view from the bottom and up into the magazine well of a modified handgrip in accordance with aspects of alternate embodiments. As can be seen from the illustration, part of the back of a stock handgrip has been milled away to expose the magazine well backside 302 and to produce a dovetail socket as illustrated in FIG. 4 and described above. In this embodiment, an indent 1501 is also formed into the magazine well backside. A matching nub or mound of material in an ergonomic insert can fit into the indent when the ergonomic insert is properly positioned in the handgrip. As such the ergonomic insert can be removed given the proper amount of force applied in the proper direction. Note that the elasticity of the handgrip and insert materials provide for some flexing and deformation during insertion.

FIG. 16 illustrates another alternative for fixing an insert 1601 into a handgrip 1606 in accordance with aspects of alternate embodiments. The handgrip has a dovetail socket 1603 having edges 1604 into which a dovetail shaped insert 1601 can slide. The insert 1601 can be removably fixed into the dovetail socket 1603 by forming widened sections 1605 into the edges 1604 that match bulging sections 1602 in the insert 1601.

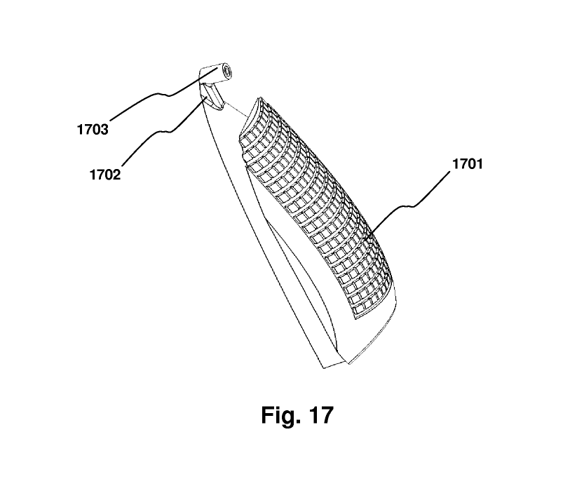

FIG. 17 illustrates yet another alternative for fixing an insert into a handgrip in accordance with aspects of alternate embodiments. An ergonomic insert 1701 can have a clipping retention structure having a clip 1703 instead of the pin hook 501 of FIG. 5. The clipping retention structure can have an extension 1702 with a clip 1703. The clip 1703 can snap into a hole in the handgrip when the ergonomic insert 1701 is properly positioned within the hand handgrip. A stock handgrip can be sequentially milled and drilled. The clip 1703 snaps into the hole from inside the handgrip and can be pressed back out of the hole with any suitably sized tool or even a pencil or small dowel. Pressing the clip 1703 out of the hole frees the ergonomic insert to be removed from the handgrip.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for modifying a firearm frame, the method comprising:
obtaining a firearm frame wherein the firearm frame comprises a hand grip, wherein the hand grip comprises a magazine well, a back cavity, and a rear wall, wherein the rear wall is plastic, wherein the back cavity is enclosed front, back, left, and right by a common wall and the rear wall, wherein the back cavity and the magazine well share the common wall, and wherein the rear wall curves to enclose the back cavity from behind, left, and right; and
machining the rear wall to thereby form a retention socket from the back cavity such that the handgrip comprises the retention socket.

2. The method of claim 1 further comprising installing an ergonomic insert into the retention socket.

3. The method of claim 2 wherein the ergonomic insert provides a palm relief.

4. The method of claim 2 wherein the ergonomic insert is fixed in place by a pin and wherein removing the pin allows the ergonomic insert to be removed from the handgrip.

5. The method of claim 1 wherein the retention socket is a dovetail socket.

6. The method of claim 5 further comprising installing an ergonomic insert into the dovetail socket wherein the ergonomic insert comprises a dovetail.

7. A method for modifying a firearm frame and a trigger mechanism, the method comprising:
obtaining the firearm frame wherein the firearm frame comprises a hand grip, wherein the hand grip comprises a magazine well, a back cavity, and a rear wall, wherein the rear wall is plastic, wherein the back cavity is enclosed front, back, left, and right by a common wall and the rear wall, wherein the back cavity and the magazine well share the common wall, wherein the rear wall curves to enclose the back cavity from behind, left, and right;
obtaining the trigger mechanism wherein the trigger mechanism comprises a block that fits into the firearm frame and is held therein by a pin;
machining the rear wall to thereby transform the back cavity into a retention socket such that the handgrip comprises the retention socket; and
machining the block such that the pin is exposed when inserted.

8. The method of claim 7 further comprising installing an ergonomic insert into the retention socket.

9. The method of claim 8 wherein the ergonomic insert provides a palm relief.

10. The method of claim 8 wherein the ergonomic insert is fixed in place by the pin and wherein removing the pin allows the ergonomic insert to be removed from the handgrip.

11. The method of claim 7 wherein the retention socket is a dovetail socket.

12. The method of claim 11 further comprising installing an ergonomic insert into the dovetail socket wherein the ergonomic insert comprises a dovetail.

13. The method of claim 7 further comprising providing a plurality of ergonomic inserts wherein each of the ergonomic inserts fits into retention socket to thereby provide a plurality of palm reliefs.

14. The method of claim B7 wherein the ergonomic inserts are removably fixed in place by the pin.

15. A method for producing an ergonomic handgrip for a firearm the method comprising:
producing a firearm handgrip comprising at least one retention socket such that the firearm handgrip comprises the retention socket;
inserting an ergonomic insert into the retention socket wherein the ergonomic insert comprises a retention structure and a palm relief to thereby modify the firearm handgrip to have an ergonomic profile.

16. The method of claim 15 further comprising inserting a pin into a pinning hole to thereby pin the ergonomic insert into the firearm handgrip.

17. The method of claim 16 wherein the at least one retention socket is a dovetail socket and wherein the retention structure is a dovetail.

18. The method of claim 17 wherein the dovetail and the dovetail socket mate to form a sliding dovetail joint and wherein the ergonomic insert is pinned into the firearm handgrip.

19. The method of claim 18 further comprising:
unpinning the ergonomic insert; and
sliding the ergonomic insert out of the firearm handgrip.

20. The method of claim 19 comprising:
sliding into the firearm handgrip a second insert that also comprises a retention structure and a palm relief; and
pinning the second insert into the firearm handgrip to thereby modify the firearm handgrip to have a second ergonomic profile.
